(19) United States
(12) Patent Application Publication
(10) Pub. No.: US 2014/0337078 A1
(43) Pub. Date: Nov. 13, 2014

(54) PRODUCT SELECTION BASED ON SALES LOCATION

(71) Applicant: Security Mutual Life Insurance Company of New York, Binghamton, NY (US)

(72) Inventors: Scott A. Sylvester, Binghamton, NY (US); Oliver T. Hicks, Binghamton, NY (US)

(21) Appl. No.: 14/335,671

(22) Filed: Jul. 18, 2014

Related U.S. Application Data
(63) Continuation of application No. 13/940,714, filed on Jul. 12, 2013.
(60) Provisional application No. 61/699,635, filed on Sep. 11, 2012.

(51) Int. Cl. G06Q 30/06

(52) U.S. Cl. CPC G06Q 30/0639
USPC 705/7.18; 705/26.9

(57) ABSTRACT

The present inventive subject matter is drawn to systems, configurations, and methods that assist salespersons of an organization to conduct in-person sales at a remote location by automatically selecting a subset of products that are available for sales to salespersons at the remote location. In one aspect of the invention, the systems, configurations, and methods detect the location of the in-person sales meeting between the salesperson and a potential customer and automatically display the subset of products that is available for sales based on the location of the sales meeting and a set of rules.

This application claims the benefit of U.S. application Ser. No. 13/940,714 entitled “Product Selection Based on Sales Location” filed Jul. 12, 2013, which claims the benefit of U.S. provisional application No. 61/699,635, filed Sep. 11, 2012. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The present invention relates to a distributed system for managing remote sales activities.

### BACKGROUND

The following description includes information that may be useful in understanding the present invention. It is not an admission that any of the information provided herein is prior art or relevant to the presently claimed invention, or that any publication specifically or implicitly referenced is prior art.

For some companies, product offerings to potential customers depend on many factors. For example, some companies offer certain products based on the residential location of the potential consumer. Others restrict the sales of certain products based on the location of the sales. In addition, some companies even restrict the sales of certain products based on a salesperson's designation.

As the number of limitations and restrictions increases, the task of conducting sales becomes more difficult. A salesperson's job becomes even more complicated when the location of sales changes frequently. For example, for certain industries in which personal relationships with potential customers are critical in generating sales, salespersons often conduct in-person sales meetings at locations that are convenient to the potential customers (e.g., at the potential customer's residence, at a neutral location such as a coffee shop, at the premise of a third party that has an established relationship with the potential customer). In these cases, the salespersons must determine which products are available for sale at the location of the meetings before or during the meetings. Furthermore, the product offering limitations may change from time to time due to a change of strategy by the company. The efforts that the salespersons must put forth to make these determinations are time consuming and complicated and distract them from their main task, which are sales. Due to the pressure of closing sales activities in front of a potential customer, the amount of time it takes to make proper determinations and the complexity of the process, the sales person can make mistakes which can be costly and embarrassing for the sales person and the company.

Efforts have been made to determine product offerings based on location. For example, U.S. patent publication 2012/0123675 to Parker titled “Method and System for Operating and Interacting with Virtual Marketplace”, filed Nov. 16, 2010, discloses a method for identifying product information based on user's input of a physical location of a user. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

However, the system disclosed in Parker is only applicable in a virtual marketplace setting, in which the availability of certain products depend only on the permanent physical location of the user, which doesn't vary from potential customer to potential customer. Thus, there is still a need to improve on such a system such that it can be used for sales that are conducted in, and product availability based upon, different remote locations where sales are occurring, and does not rely only on permanent physical location of the user.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The present inventive subject matter is drawn to systems, configurations, and methods of automatically selecting a set of products that are available for sales to salespersons at remote locations. In one aspect of the invention, a sales management system for assisting salespersons of an organization to conduct in-person sales at remote locations is presented.

In some embodiments, the system may comprise a distal service, which may be communicatively coupled with multiple portable devices. The distal service may comprise a distal storage and a distal calendaring system. In some embodiments, the distal storage may store information associated with the set of products that is available for sales by the organization. The set of products may include tangible and/or intangible products. The set of products stored in the distal storage may also be updated from time to time by the organization.

In addition to the set of products, the distal storage of some embodiments may also store a set of rules related to the availability of the set of products for different salespersons and/or different geographical regions. The set of rules may also include rules that define a subset of products that is available for sales in a specific region, such that different subsets of products are available when the sales are conducted in different regions. The set of rules may also include a variety of rules that depend on different factors defined by the organization. In some embodiments, the distal calendaring system may store information associated with the schedules of the salespersons of the organization, such as time and location of different in-person sales meetings. This information may be updated by the organization or by the salespersons.

A portable device of some embodiments may be associated with a salesperson, and may comprise a sales manager module that may be communicatively coupled with an input module, a memory, a location determination module, a processor and a display configured to cooperate to display a subset of the products available for sale selected based at least in part on an output of the location determination module, a sale order processing module, and an interface through which the device communicates with the distal service.

In some embodiments, the memory may hold a database that includes information relating to the set of products. The processor of the portable device may also be configured to communicate with the distal service to update the database with respect to the set of products. In some embodiments, the input module may be configured to receive a handwritten signature and/or a verbal signature.

In some embodiments, the processor and the display of the portable device may be configured to cooperate to display the subset of products selected based in part on a salesperson designator. The processor may also be configured in some embodiments to associate a particular sale with a particular salesperson designator. In some embodiments, the processor may be configured to communicate the output of the location determination module with the distal calendaring system via the interface. The distal calendaring system may be a standard non-proprietary calendaring system. Further, the processor in some embodiments may be configured to receive alerts from the distal calendaring system.

In some embodiments, the portable device may comprise a local calendaring system configured to (i) receive calendaring updates via the input module, (ii) store the calendaring updates in a local data storage when a communication with the distal calendaring system is detected to be interrupted, and (iii) synchronize the calendaring updates with the distal calendaring system via the interface when the communication with the distal service is detected to be restored. The calendar update, of some embodiments, may comprise information associated with a future ad-hoc sales meeting. Further, in some embodiments, if a location of the future ad-hoc sales meeting is unknown, the local calendaring system may be further configured to retrieve the location from the distal calendaring system when the communication with the distal service is detected to be restored.

In one aspect of the invention, the systems, configurations, and methods detect the location of the in-person sales meeting between the salesperson and a potential customer, and automatically display the subset of products that is available for sales based on the location of the sales meeting and the set of rules.

In some embodiments, a remote sales manager of the portable device retrieves the information associated with the set of products available for sale by the organization, the set of rules governing the availability of the set of products, and the schedule of the salesperson from the distal service.

In some embodiments, during the sales meeting, the salesperson may request that the remote sales manager lists a set of products that can be presented to the potential customer. As mentioned, the determination of product offerings may depend on the physical location of the sales meeting, the salesperson's designator, or other factors. Thus, upon such request, the remote sales manager of some embodiments may retrieve the physical location information from the location determination module and may update the distal service, and may use the set of rules stored in the remote storage 250 to determine a subset of products that is available for sales by the salesperson at the location of the sales meeting.

In some embodiment, after determining the subset of products that is available for sales, the remote sales manager may instruct the output module to display the subset of products to the salesperson. In addition to presenting product information, the remote sales manager may also allow the salesperson to make a purchase order through the input module and the output module. If the purchase order also requires one or more signatures, from the potential customer and/or others, the remote sales manager may also use the input module to receive the signatures. To complete the purchase, the remote sales manager of some embodiments may send/upload information related to the purchase order and the signatures to the distal service via the interface to the distal service. The signatures in some embodiments may be handwritten, verbal, or any combination of either.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an example of an overall sales management system of some embodiments.

FIG. 2 illustrates an example portable device of some embodiments.

FIG. 3 illustrates a process for conducting an in-person sales meeting between a salesperson and a potential customer at a remote location.

FIG. 4 illustrates a process for a portable device to display a subset of products available for sales.

FIG. 5 illustrates a process for taking a purchase order of a potential customer in some embodiments.

FIG. 6 illustrates a process for detecting potential scheduling issues with remote sales meetings and automatically determining remedies therefor.

### DETAILED DESCRIPTION

It should be noted that any language directed to a computer should be read to include any suitable combination of computing devices, including servers, interfaces, systems, databases, agents, peers, engines, modules, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The present inventive subject matter is drawn to systems, configurations, and methods that assist salespersons of an organization to conduct in-person sales at a remote location by automatically selecting a subset of products that are available for sales to salespersons at the remote location. In one aspect of the invention, the systems, configurations, and methods detect the location of the in-person sales meeting between the salesperson and a potential customer and automatically display the subset of products that is available for sales based on the location of the sales meeting and a set of rules.

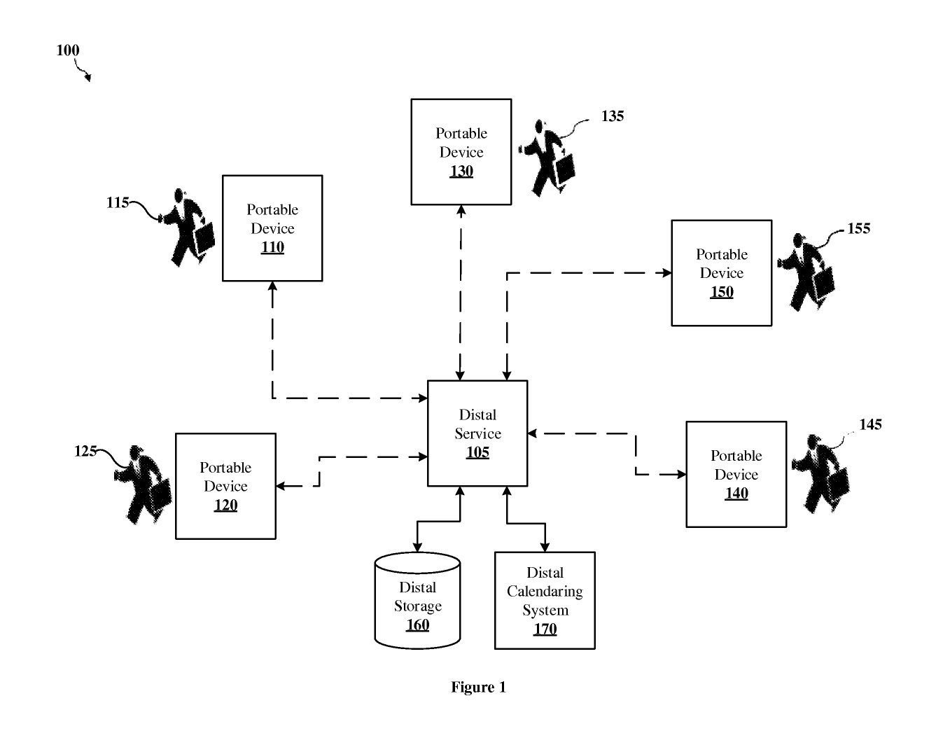

FIG. 1 conceptually illustrates an example of a sales management system 100 according to the present invention. As shown, the sales management system 100 includes a distal service 105, its related distal storage 160 and distal calendaring system 170, and multiple portable devices 110, 120, 130, 140, and 150.

In some embodiments, the distal service 105 is provided by one or more server computers. Each of the server computers may include at least one processing unit (e.g., a processor, a processor core, etc.) for executing software applications. In some embodiments, these server computers are dedicated to provide the distal service 105 for the organization. In other embodiments, the server computers also perform other functionalities for the organization. Together, these distal service server computers provide the portable devices services related to sales activities.

As shown, the distal service 105 is communicatively coupled with the distal storage 160. The distal storage 160 of some embodiments is non-transitory permanent data storage such as a hard drive, a flash memory, etc. The distal storage 160 may include one or more databases. The processing unit may query, insert, or alter relevant data stored in the database(s). In some embodiments, the distal storage 160 stores information associated with a set of products that is available for sales by the organization. The set of products stored in the distal storage 160 can also be updated from time to time by the organization.

In addition to the set of products, the distal storage 160 of some embodiments also stores a set of rules related to the availability of the set of products for different salesperson designators and/or different geographical regions. A salesperson designator identifies one or more salespersons that belong to a sales group. Sales groups may be formed on the basis of the geographical locations within which sales meetings are conducted, the product lines to be offered for sales in the sales meetings, the performance of the sales groups' members, the demographic data of the potential customers, or any other factors as deemed appropriate for the organization.

In some embodiments, the sales group may be assigned to a specific geographical location, such that a sales meeting scheduled in that location is automatically assigned to any salesperson who is a member of that sales group as defined by the set of rules, depending on the availability of the member salespersons. For example, a sales group may be formed and designated to conduct sales activities only in the southwest region of the United States, in the province of British Colombia, Canada, or in the Middle East. The rules in this case may designate unique subsets of products to be available for sales in each of the example geographical locations above.

In other embodiments, a sale group may be formed and designated to the sales activities related to insurance policies, or a subset thereof (specialty product lines such as casualty insurance, property insurance, whole life insurance, term life insurance, etc.). Similarly here, the rules may designate only certain policy products to be available for sales depending on the product line to which the sale group belong. For example, the available products should only include property insurance policies if the salesperson belongs to a sales group associated with a property insurance product line.

In yet another type of embodiments, a sales group may be based on the sales volume or performance of its members, such that a sales group may include salespersons that have high performance ratings in relation to their sales activities. In such embodiments, the organization may choose to designate high performing salespersons to one or more sales groups, and direct such sales groups in a manner consistent with its marketing and/or sales strategies. For example, an organization may form one or more sales groups consisting of top performing salespersons to target areas where sales activities has plummeted within the a certain period of time.

In some embodiments, the set of rules can also include rules that define a subset of products that is available for sale by a sales agent in a specific geographical region, such that different subsets of products are available for sale by the sales agent when the sales are conducted in different regions. In these embodiments, the rules define subsets of products available for sales solely based on the physical location in which a given sales meeting is to be held. Thus, the subset of products available for sale may change if a sales meeting, which is scheduled to be held in southern California, is then moved to northern California. In this case, the set of rules may alter the subset of products presented to the potential customer if the meeting is held in the city of San Francisco instead of the city of Los Angeles.

In some embodiments the set of rules also includes rules that further define the subset of products that is available for sale by the sale agent to not only depend on the physical location of the sales agent, but to also depend on the physical location of another entity (e.g., a more superior sales agent, a partner entity to the organization to which the sales agent belong, etc.). For example, the rules can specify that the sales agent can sell a particular life insurance product in Northern California, but that no sales agent can sell that particular life insurance product within 10 miles of a more superior sales agent. Using the above example, when the sales agent is conducting a sales meeting in Northern California, the portable device would alter the subset of sales product further to eliminate the particular life insurance if the physical location of the sales agent is within 10 miles of the superior sales agent.

In addition to a superior sales agent, the other entity that can limit the set of products that the sales agent can sell can be a bank or another organization that has a partner relationship with the organization to which the sales agent belong.

It has been contemplated that there are different ways to determine the physical location of the other entity. In some embodiments where the different entity is a superior sales agent that belongs to the same organization to which the sales agent belongs, the superior sales agent is provided with a portable device that is similar to portable device 210 of the sales agent. In these embodiments, the superior sales agent's portable device also includes a location determination module that keeps track of the physical location of the superior sales agent, and periodically (e.g., every 5 minutes, every hour, etc.) sends the physical location to the distal service 105. The distal service 105 then passes the physical location information to the portable device 210 of the sales agent. The remote sales manager 220 then uses the physical location information of the superior sales agent to further alter the set of products available to present to the sales agent when necessary, based on the physical location of the sales agent.

In some other embodiments, information about the schedule of the superior sales agent is stored in the distal calendar system 170. In these embodiments, the distal service 105 can send the most updated calendar information of the superior sales agent (and any other superior sales agents if they exist) to the portable device 200 periodically (e.g., every day), so that the remote sales manager 220 can use the location information of the superior sales agent to determine the subset of products to present to the sales agent upon request.

In some other embodiments, the physical location of the other entity (e.g., a bank, a credit union, etc.) is fixed. The fixed location information is then stored in the remote storage 250 of the portable device 210 so that the remote sales manager 220 can use the location information to determine the set of products to present to the sales agent upon request.

The set of rules may also include a variety of rules that depend on different other factors as may be defined by the organization. As such, one who is skilled in the art would appreciate that more than one rule can apply to determine the subset of products that are available for sales in a particular instance. Therefore, in some embodiments the subset of products can be dependent upon multiple factors, including a combination of the geographical location of the sales meeting, the identity of the salesperson or sales group, etc.

Additionally, the set of rules may also be updated by the organization from time to time. For example, the organization may modify the set of rules for no specific reason, or to transition from forming sales groups by geographical locations and reform its sales groups based on the sales volume of the member salespersons to address business difficulties. In these situations, the organization may have experienced difficulties closing sales related to certain insurance policies within a certain product line or geographical location. Upon further assessment, the organization may rethink its strategy by dismantling its sales groups that are designated simply to different geographical locations, and replacing them with other new sales groups that are based on the performance of their members. Thereby, the organization may group top performing salespersons, as mentioned, to target the suffering product line(s) or geographical locations. Therefore, the distal service 105 may provide the ability for the organization to modify the set of rules stored in its related distal storage 160 for any reason.

Also shown in FIG. 1, the distal service 105 is communicatively coupled with a distal calendaring system 170. In some embodiments, the distal service 105 may use the calendaring system 170 to store and manage scheduling information. The scheduling information may be associated with the different in-person sales meetings of salespersons with potential customers. The scheduling information may include information such as time and location of different in-person sales meetings. The scheduling information may also include profile information of the salespersons and of the potential customers. The scheduling information may be updated by the organization or by the salespersons from time to time, as further discussed in detail below.

Referring to FIG. 1, each of the portable devices 110, 120, 130, 140, and 150 is associated with a salesperson 115, 125, 135, 145, and 155. Preferably, the salespersons carry their corresponding portable devices when they conduct sales related activities at remote locations. The distal service 105 is also communicatively coupled with the portable devices 110, 120, 130, 140, and 150 for facilitating sales of the subset of products through in-person sales meetings. The distal service 105 is connected through wireless connections (e.g., a cellular network, a wireless Internet connection, etc.) to each of the portable devices 110, 120, 130, 140, and 150. Preferably the wireless connections between the distal service 105 and the multiple portable devices has sufficient range such that the portable devices can maintain connectivity with the distal service when the salespersons are conducting sales activity across towns, cities, or even countries.

It is also noted that the connection between the distal service 105 and the portable devices 110, 120, 130, 140, and 150 need not be continuously active during a sales presentation, or even at all, for a sales transaction to occur. The design of the sales management system 100 allows a salesperson to conduct a sales transaction using any one of the portable devices 110, 120, 130, 140, and 150 even when the portable device is disconnected from the distal service 105. In some embodiments, the portable devices 110, 120, 130, 140, and 150 are configured to store information related to a sales transaction in its related data storage when disconnected from the distal service 105, and while the sales transaction is taking place. The portable devices 110, 120, 130, 140, and 150 of some embodiments are also configured to synchronize the products and sales information with the distal service 105 whenever the connection with the distal service 105 is restored.

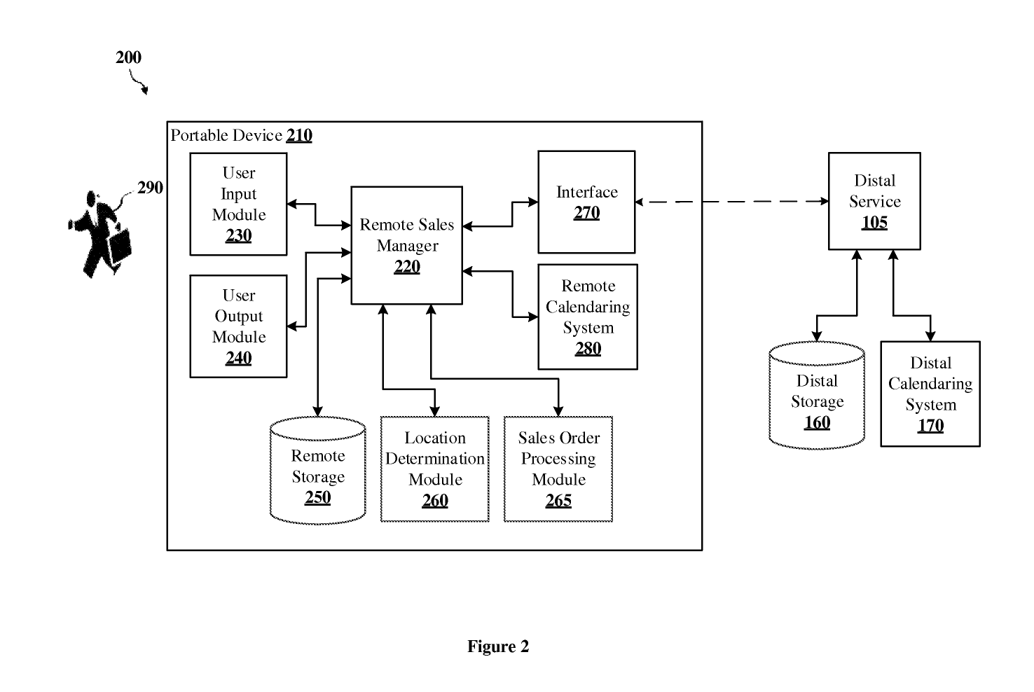

FIG. 2 conceptually illustrates an example portable device 210 (which should be interpreted in this application as corresponding to any or each of devices 110, 120, 130, 140, and 150). As shown, the portable device 210 includes a remote sales manager 220, a location determination module 260, a remote storage 250, a user input module 230, a user output module 240, a sales order processing module 265, an interface 270, and a remote calendaring system 280. In some embodiments, the remote sales manager 220, the location determination module 260, the user input module 230, the user output module 240, the sales order processing module 265, the remote calendaring system 280, and the interface 270 are software modules that can be executed by the portable device 210 to perform different functions. Specifically, the remote sales manager 220 of the portable device 210 manages the remaining modules to perform different sales related functionalities. The remote sales manager 220 of some embodiments also allows the salesperson 290 to modify his/her schedule through the user input module 230. As mentioned, each portable device is associated with a salesperson in a preferred embodiment. In this example, the portable device 210 is used by salesperson 290.

In some embodiments, the portable device 210 includes at least one processing unit (e.g., a processor, a processor core, etc.), an input unit (e.g., a keyboard, a mouse, a touch-sensitive screen, etc.) for receiving inputs from the salesperson 290 or other users, an output unit (e.g., a display, monitor, portable printer, etc.) for displaying the subset of products available for sale or other information to the salesperson 290, and a communication unit (e.g., a wireless transceiver, such as a Wi-Fi or Bluetooth transceiver, etc.) that is coupled to the interface 270, and is configured to communicate with the distal service 105. The location determination module 260 of some embodiments is coupled with a location tracking device (e.g. a GPS system) that is installed within or in proximity of the portable device 210. The portable device 210 may also include software components/modules that are stored in memory (e.g., random access memory, hard-drive, flash memory, etc.) and are executed by the processing unit to perform different sales-related functionalities.

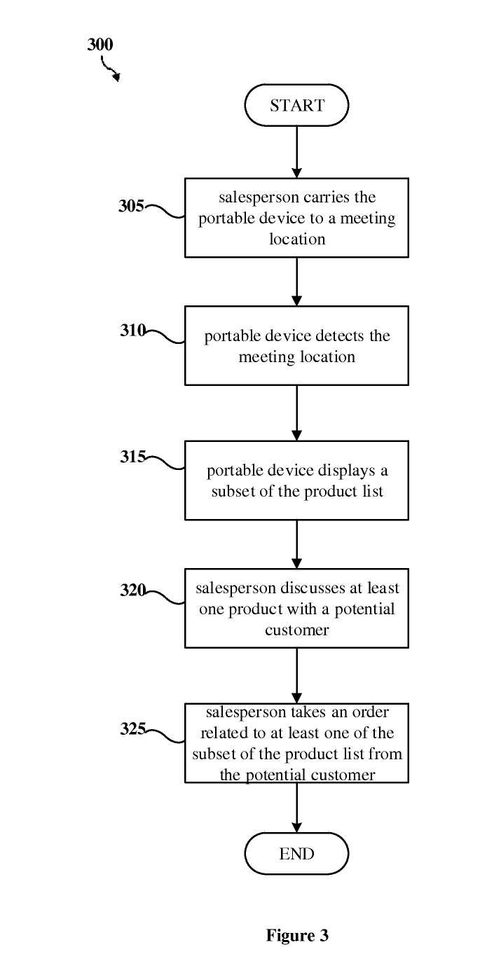

FIG. 3 outlines a preferred embodiment of a process 300 to conduct an in-person sales meeting between the salesperson 290 and a potential customer at a remote location. The process 300 will now be described by reference to FIG. 2. In step 305, the salesperson 290 carries the portable device 210 to a sales meeting location. In some embodiments, the salesperson 290 may provide identification information (log-on or credentials of the salesperson, etc.) to the remote sales manager 220 at the initiation of the portable device 210, or upon request by the remote sales manager 220. Thereby, the salesperson 290 may be associated with the corresponding portable device 210 prior to conducting the in-person sales meeting. The salesperson 290 may provide the authentication information via the user input module 230. The remote sales manager 220 may verify the authentication information with the profile information of the salesperson 290 that may be stored in the remote storage 250. Alternatively in some embodiments, the remote sales manager 220 may verify the authentication information with the profile information of the salesperson 290 that is stored in the distal storage 160 by communicating with the distal service 105.

Upon arrival at the remote meeting location successfully logging onto the portable device 210 (or a remote sales service being executed by the portable device), the portable device 210 of some embodiments detects the physical meeting location as shown in step 310. In other embodiments, the remote sales manager 220, of the portable device 210, uses the location determination module 260 to detect the remote meeting location. As mentioned, the location determination module 260 may employ a location tracking device to determine the current physical location of the portable device 210. Once the physical location of the portable device 210 is detected, the remote sales manager 220 may store and associate the detected location as the meeting location. In some embodiments, the remote sales manager 220 may store the meeting location in the remote storage 250, and may also associate the meeting location with the logged-in salesperson 290 and with the potential customer, by storing this information in a temporary memory location.

In the next step of the process 300 as illustrated in step 315, the portable device 210, and preferably upon the salesperson's 290 request, displays a subset of products available for sales to the potential customer. In some embodiments, the potential customer can be a new customer, an existing customer who has purchased products from the organization in the past, or who has pending purchase orders. In step 320, the salesperson 290 discusses at least one of the subset of products with the potential customer for sales purposes. Next in step 325, the salesperson 290 takes an order from the potential customer in relation to at least one of the subset of products.

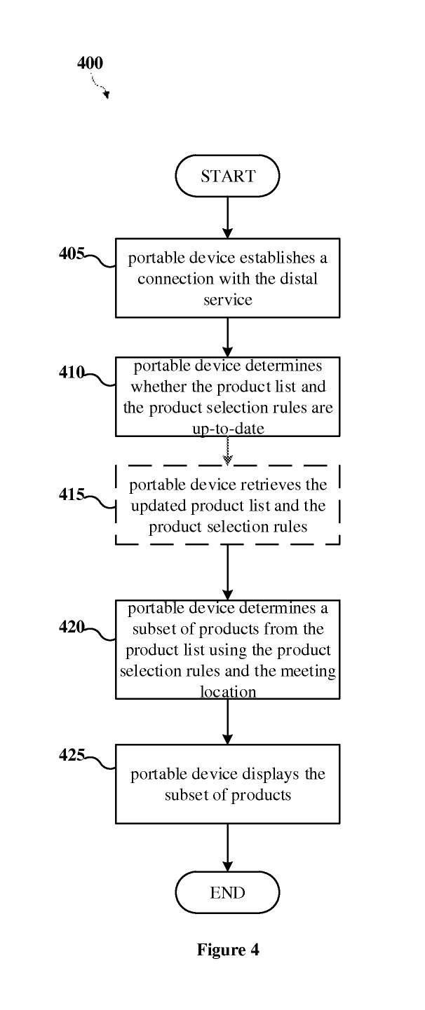

FIG. 4 illustrates a preferred embodiment of the steps necessary for the portable device 210 to display the subset of products available for sales as in step 315. Preferably after the portable device 210 detects the physical meeting location in step 310, the portable device 210 establishes a connection with the distal service 105 in step 405. As mentioned, the connection established with the distal service 105 may be a wireless connection. In some embodiments, the sales manager 220 coordinates with the interface 270 to establish the connection to the distal service 105.

In step 410 the portable device 210 determines whether the product list and product selection rules stored in its related remote storage 250 is up-to-date in comparison to what is stored in the distal storage 160. In some embodiments, the remote sales manager 220 may make this determination by communicating with the distal device 105 through the interface 270 and requesting verifying information that identifies the version of the relevant data (the product list, product selection rules, etc.) stored in the distal storage 160. Examples or such verifying information may be the last modified date of the relevant data or another mechanism to determine whether the relevant data in the remote storage 250 is identical to the corresponding relevant data in the distal storage 160. If an update is available, the updated information associated with the set of products available for sale by the organization and the set of rules governing the availability of the set of products, and other relevant data, may be retrieved from the distal service 105 and stored locally at the remote storage 250, as shown in step 415. In some embodiments, the remote sales manager 220 may instruct the interface 270 to retrieve the updated information about the set of products and the set of rules from the distal service 105.

Instead of or in addition to the physical location of the sales meeting, the determination of the subset of products may depend on many other factors, as mentioned. In such embodiments, the remote sales manager 220 may retrieve relevant information (e.g., the salesperson's identity or designator, locations of other salespersons, sales volume of salespersons, etc.) from the remote storage 250, or from the distal service 105 and its distal storage 160, before determining the subset of products. In some embodiments, the exact nature and scope of the other relevant data to be retrieved by the remote sales manager 220 will be dynamically determined based on the updated set of rules of selecting the subset of products. For example, if the updated set of rules dictate the selection of the subset of products based on the sales group membership of the salesperson, then the relevant data to be retrieved must include the salesperson's 290 sales group membership information.

In step 420, the portable device 210, or its remote sales manager 220 in the preferred embodiment, determines a subset of products from the updated product list using the updated product selection rules and the detected meeting location. In some embodiments, after determining the subset of products available for sales, the remote sales manager 220 of the portable device 210 may instruct the user output module 240 to present the subset of products to the salesperson 290 or others, as shown in step 425. In some embodiments, the user output module 240 may be coupled to a screen, a printer, a speaker, a combination of any of the mentioned output devices, or another output device. In other embodiments, the portable device 210 may have the ability connect to external output devices, such as computer monitors or portable printers. The remote sales manager 220 may give the salesperson 290 or another user the option to display the subset of products through any of the available output devices. The salesperson 290 will make input a selection of one or more output devices to present the information (for example, the salesperson may select to print the subset of products). The remote sales manager 220 will then instruct the user output module 240 to present the subset of products using the selected output device(s) (a printer in this example).

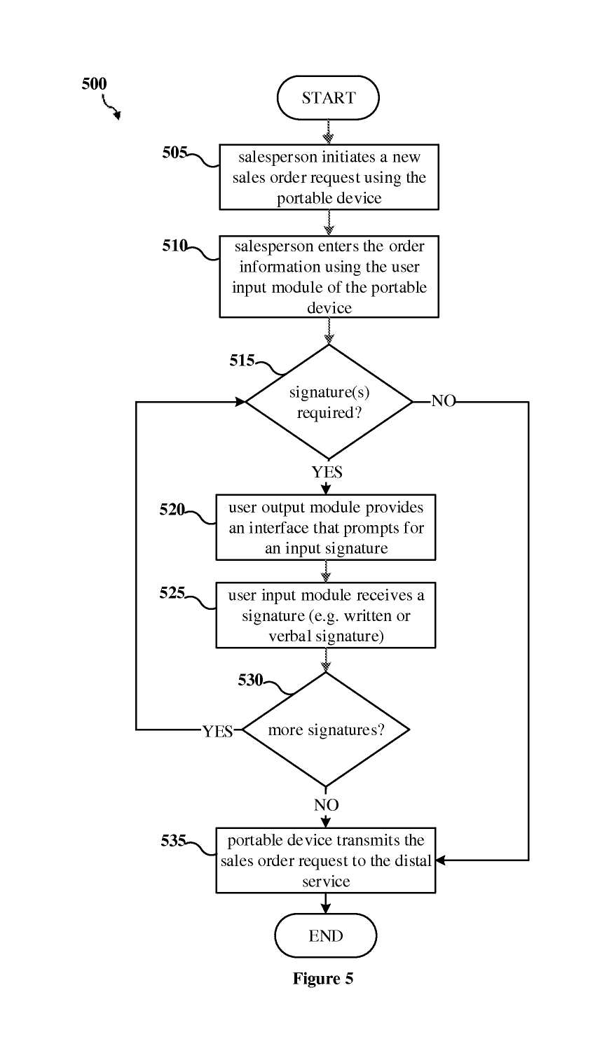

As illustrated in FIG. 3, after the salesperson 290 had a chance to discuss at least one of the subset of products with the potential customer, the potential customer may choose to purchase one or more products of the subset. The salesperson 290 may then proceed to take the customer's order as indicated in step 325. In some embodiment, and in addition to presenting product information, the remote sales manager 220 may also allow the salesperson 290 to make a purchase order through the user input module 230 and the user output module 240. FIG. 5 illustrates the process of taking the customer's purchase order in some embodiments. In step 505, the salesperson 290 may initiate a new sales order request using the portable device 210. In some embodiments, the salesperson 290 may use the user input module 230 to initiate the new sales order, and to input order information, as shown in step 510.

In some embodiments, a pending purchase order that is associated with a specific potential customer may already exist. The salesperson 290 may request the portable device 210 to retrieve the information of this pending purchase order prior to discussing at least one of the subset of products with the potential customer for sales purposes, in step 320 above. As such, upon the potential customer selecting one or more products of the subset of products for purchase, the salesperson 290 may request the portable device 210, or the remote sales manager 220, to add the selection to the pending purchase order. Also in some embodiments, the salesperson 290 may have the option to save the purchase order information for future processing or to complete and upload/send the order information to the distal device 105. If the salesperson 290 decides to the save the purchase order information, the portable device 210 may save the information locally at the remote storage 250. In other embodiments, the portable device 210 may save the information of the pending purchase order at the distal service 105 via the interface 270.

In step 515, a determination is made regarding whether the purchase order also requires one or more signatures, from the potential customer and/or others. If the one or more signatures are required to complete the purchase order, the portable device 210 may provide an interface (via the user input module 230 and the user output module 240 for example) to prompt for and receive the signature(s), as illustrated in steps 520 and 525. In some embodiments, the potential customer can provide a handwritten signature through a touch sensitive screen. In other embodiments, the portable device 210 may also include a microphone for receiving a verbal signature. In some of these embodiments, the portable device 210 is configured to receive at least one handwritten signature and/or at least one verbal signature for the purchase order. In other embodiments, the remote sales manager 220 manages the signature collection process, including communicating with available user input and user output modules.

To complete the purchase order, the portable devices 210 of some embodiments sends/uploads information related to the purchase order and the signature(s) to the distal service 105 via the interface 270, as shown in step 535. However, in the event that the connection between the distal service 105 and the portable device 210 cannot be established, the portable device 210 stores the information related to the purchase order and the signature(s) in the remote storage 250, and sends them to the distal service 105 when the connection is restored. Also, in some embodiments, the remote sales manager 220 will undertake the responsibilities illustrated here in step 535.

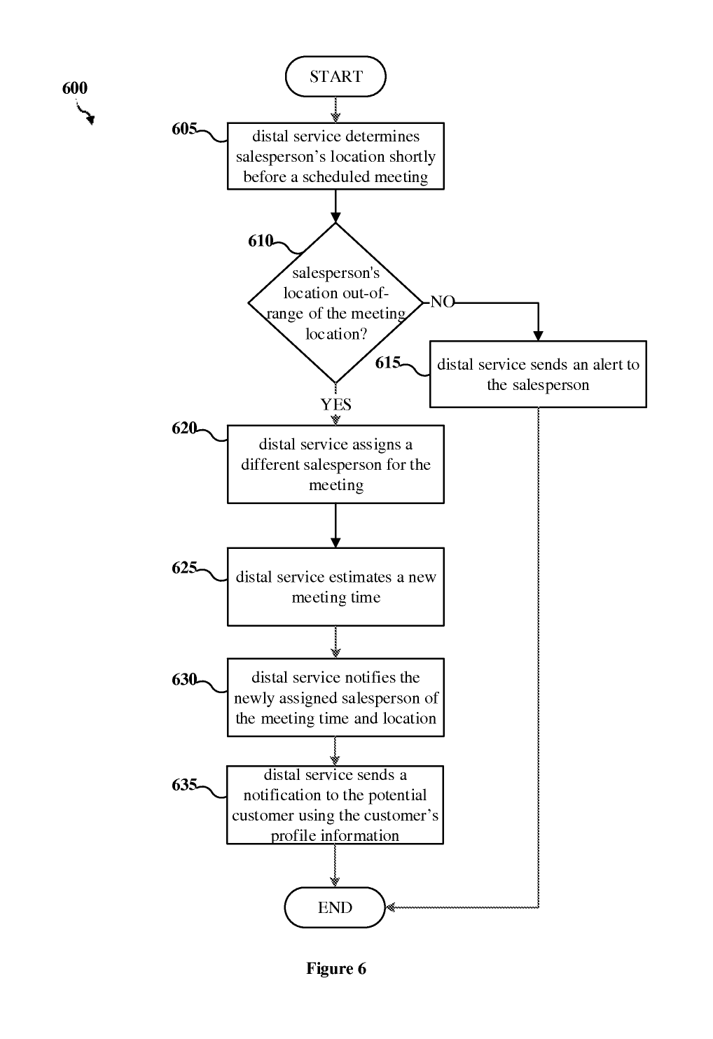

In some embodiments, the distal service 105 manages the salespersons' schedules. FIG. 6 illustrates a preferred embodiment of the typical communication protocol between the distal service 105 and the portable device 210 associated with the salesperson 290 in that regards. In step 605, the distal service 105 determines the salesperson's location shortly before a scheduled in-person sales meeting.

As mentioned, the distal device 105 may be able to communicate with the portable device 210 associated with a certain salesperson 290 after the salesperson 290 successfully identifies with the portable device 210. In some embodiments, the distal service 105 communicates with the corresponding portable device 210 via the interface 270 to request the current physical location of the portable device 210. The remote sales manager 220 may instruct the location determination module 260 to detect the physical location of the portable device 210, as discussed above, and may communicate this information back to the distal service 105.

The distal service 105 may determine whether the salesperson's location is out-of-range of the scheduled meeting location, as in step 610. If the salesperson location is within range of the in-person sales meeting, the distal service 105 may send a meeting alert to the salesperson 290. In some embodiments, the distal service 105 sends the alert to the corresponding portable device 210 via the interface 270.

If the salesperson's location is out-of-range from the in-person meeting location, the distal service 105 assigns a different salesperson to the subject in-person sales meeting, as shown in step 620. For example, if the salesperson 290 has a scheduled meeting in southern California, but the current physical location of the portable device 210 indicated that North East region of the United States. In some embodiments, the salesperson 290 may belong to a sales team or group assigned to a geographical area that includes the meeting location. Therefore, the distal service 105 may select among the members of the sales team or group to find a new salesperson to be assigned. In some embodiments, the distal service 105 may verify the current location and schedule of the new salesperson, to determine that salesperson's availability to conduct the in-person sales meeting (for example, if the new salesperson's location is within a certain range from the meeting location, if the schedule of the new salesperson is open, etc.). Therefore, in this example, the distal service 105 will search for a new salesperson of the same sales group who is currently located within the southern California area and who has an open schedule. The distal service 105 may determine the location and schedule of the new salesperson by retrieving the corresponding information from the associated portable device and from the distal calendaring system 170. The distal service 105 may select among members of other sales teams or groups, if none of the other members of the salesperson's 290 group are available for any reason. The distal service 105 may conduct its search by exhausting sales groups that are assigned to the geographical area desired, before expanding the search to sales groups that belong to other geographical areas.

In some embodiments, the distal service 105 may determine a new time for the in-person meeting, as in step 625. The distal device 105 may use the schedule and current location of the new salesperson to determine the new time of the in-person sales meeting. The distal device 105 may utilize its distal storage 160 and distal calendaring system 170 to make such a determination. For example, the distal service 105 may determine the address where the new salesperson is and may then estimate the arrival time of the new salesperson from the determined address to the originally scheduled meeting location. On the basis of this calculation, the distal service 105 may be able to determine a new meeting time for the in-person sales meeting between the new salesperson and the potential customer.

The distal service 105 may then proceed to notify the new salesperson of the in-person meeting information (for example, new meeting time, location, any other relevant information, etc.), as in step 630. Also in some embodiments, as shown in step 635, the distal service 105 may use the contact information of the potential customer to send a notification to the potential customer containing the information of the new meeting. In some embodiments, the distal service 105 may have access to the profile or other contact information of the potential customer, which may be stored in the distal storage 160.

As mention above, the connectivity between the distal service 105 and the portable device may not be active at all time. As such, it is inevitable that the distal service 105 may be out of sync with any given portable device in regards to the data stored in the corresponding storage or calendaring system components. Thus in some embodiments, the remote sales manager 220 may instruct the interface 270 to establish a connection with the distal service 105 from time to time (e.g., at a predetermined interval) for data synchronization purposes. If the connection is established, the remote sales manager 220 synchronizes the information stored in the remote storage 250 with the distal service 105. Such synchronization process may include any updated information associated with any of the purchase orders, the products, the rules, or the calendaring items to be uploaded/sent to the distal service 105. In some embodiments, the portable device 210 can indicate to the salesperson that the information stored therein is out of date when the portable device has not been able to establish a connection for synchronizing the data for a predetermined period of time (e.g., one day, a few hours, etc.). In addition, the portable device 210 can also be configured to not display the subset of products and prevent the salesperson from making any sales order request (e.g., display an error message, etc.) in this situation.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . . and N, the text should be interpreted as requiring only one element from the group, not A plus N, or B plus N, etc.

What is claimed is:

1. A portable device associated with a first salesperson and that cooperates with a distal service to facilitate sales of a set of products through in-person sales meetings, the device comprising:
a location determination module configured to determine location information of the first salesperson;
an interface through which the device communicates with the distal service; and
a processor and a display configured to:
receive location information of a second salesperson from the distal service via the interface,
upon a request from the first salesperson, select a subset of products from the set of products based at least in part on the location information of the first salesperson and the location information of the second salesperson, and
display the subset of products via the display.

2. The portable device of claim 1, further comprising a memory that holds a database that includes information relating to the set of products.

3. The portable device of claim 2, wherein the processor is further configured to communicate with the distal service to update the database with respect to the set of products.

4. The portable device of claim 1, wherein the processor is further configured to cooperate to select the subset of products selected based in part on a salesperson designator.

5. The portable device of claim 1, wherein the processor is further configured to associate a particular sale with a particular salesperson designator.

6. The portable device of claim 1, further comprising an input module configured to receive a handwritten signature.

7. The portable device of claim 1, further comprising an input module configured to receive a verbal signature.

8. The portable device of claim 1, wherein the processor is further configured to communicate the output of the location determination module with a distal calendaring system via the interface.

9. The portable device of claim 8, wherein the distal calendaring system is a standard calendaring system.

10. The portable device of claim 8, wherein the processor is further configured to receive alerts from the distal calendaring system.

11. The portable device of claim 8, further comprising a local calendaring system configured to (i) receive calendaring updates via an input module, (ii) store the calendaring updates in a local data storage when a communication with the distal calendaring system is detected to be interrupted, and (iii) synchronize the calendaring updates with the distal calendaring system via the interface when the communication with the distal service is detected to be restored.

12. The portable device of claim 11, wherein the calendar updates comprise information associated with a future ad-hoc sales meeting.

13. The portable device of claim 12, wherein a location of the future ad-hoc sales meeting is unknown, wherein the local calendaring system is further configured to retrieve the location from the distal calendaring system when the communication with the distal service is detected to be restored.

14. The portable device of claim 11, wherein the calendar updates comprise the location information of the second salesperson.

15. The portable device of claim 1, wherein the processor is further configured to provide a user interface via the display that enables the first salesperson to present and conduct a sales with respect to the subset of products.

16. The portable device of claim 1, wherein the processor selects the subset of products by:
selecting a first subset of products from the set of products based on the determined location information of the first salesperson, and
excluding at least one product from the first subset of products to generate the subset of products based on the determined location information of the second salesperson.
